(19) United States
(12) Patent Application Publication
(10) Pub. No.: US 2024/0310109 A1
(43) Pub. Date: Sep. 19, 2024

(54) REFRIGERATING APPLIANCE WITH A DOOR HINGE

(71) Applicant: ELECTROLUX APPLIANCES AKTIEBOLAG, Stockholm (SE)

(72) Inventors: Omar FURLAN, Porcia (IT); Alex SCHIAVON, Porcia (IT)

(21) Appl. No.: 18/578,039

(22) PCT Filed: Jul. 14, 2021
(86) PCT No.: PCT/EP2021/069633

§ 371 Date: Jan. 10, 2024

(51) Int. Cl. F25D 23/02; E05D 5/06; E05D 5/10; E05D 5/12

(52) U.S. Cl. CPC F25D 23/028; E05D 5/06; E05D 5/127; E05D 2005/108; E05Y 2900/31; F25D 2323/024

(57) ABSTRACT

Household appliance (2), especially refrigerating appliance, comprising a casing (4) with a door hinge (100), whereby said door hinge (100) comprises a hinge bracket (142) and a pin (148) which is inserted into a corresponding hinge seat (162) provided on said hinge bracket (142), whereby said pin (148) comprises an essentially cylindrical part (154) with two ends (170, 172) and a deformed part (158) arranged in between said two ends (170, 172) with a diameter larger than the diameter of said cylindrical main part (154).

### FIELD OF THE INVENTION

The present invention concerns the field of refrigerating appliances, especially refrigerating and/or freezing appliances. In particular, the present invention refers to refrigerating appliances with a door hinge.

### BACKGROUND ART

Household appliances, especially for cooling or combined cooling/freezing appliances (henceforth called refrigerating appliances), can be built as separate devices or as combined devices. In a refrigerating compartment goods such as vegetables, milk products etc. are cooled, and in a freezing compartment goods such as ice cream or frozen food can be stowed. Such an appliance comprises a cooling/freezing circuit with a cooling agent and a compressor, an evaporator and a condenser. The design of the cooling system is typically optimized to allow a cooling or freezing effect in the whole compartment and to a large degree independent on the concrete position of the goods to be cooled or frozen.

The refrigerating appliance typically has at least one door for a cooling compartment with a door hinge. The door hinge is arranged at an upper surface (other than at a bottom surface and in case of multiple doors also at an intermediate surface) of the cabinet of the appliance. It is known to arrange a top cover or cross bar at the top of the appliance in a front area of the top surface to provide a cover for the hinge and to provide an aesthetically pleasing look of the appliance.

The US 2008/0203874 A1 discloses a refrigerator with a body and two pivotable doors. Provided on an upper surface of the body of the refrigerator are hinge covers to cover upper hinges of the respective doors and a top cover to prevent the swollen upper surface of the body from being exposed from the front side of the body. The hinge cover and the top cover are integrally formed with each other.

During its lifetime, the door hinge is subject to stress and strain as each operation of the door exerts forces on the hinge.

### SUMMARY OF THE INVENTION

The aim of the invention is to provide a household appliance with an improved door hinge mechanism.

### DESCRIPTION OF THE INVENTION

The invention therefore relates to a household appliance, especially refrigerating appliance, comprising a casing with a door hinge, whereby said door hinge comprises a hinge bracket and a pin which is inserted into a corresponding hinge seat provided on said hinge bracket, whereby said pin comprises an essentially cylindrical part with two ends and a deformed part arranged in between said two ends with a diameter larger than the diameter of said cylindrical main part.

Preferred embodiments of the invention are described in relation to the dependent claims and the description of the enclosed drawings.

The invention is based on the consideration that a door hinge needs to simultaneously fulfil the tasks to allow a radial rotation of the door along a predefined axis and to provide axial stability and positioning of the hinge pin.

Applicant has found that these demands can be realized by a door hinge comprising a deformed pin with an axial middle region with a larger diameter compared to the adjacent parts. By providing a deformed region it is possible to allow a correct axial positioning with respect to the bracket as well as a correct axis alignment with the door pivot axis.

Preferably the main part and said deformed part are integrally built, i.e. they are built in a one-piece design, which allows a convenient manufacturing procedure.

The pin is advantageously built with a belt-like or flange-like shape.

The pin is preferably assembled on the hinge seat through mechanical interference, which advantageously implies that the diameter of the one of the two ends cylindrical part is greater than the diameter of the seat.

Preferably, the pin is assembled on the hinge seat through welding, i.e. the pin is welded on the hinge seat, which leads to an especially stable and solid connection.

Advantageously, the pin comprises an outer thread and the hinge seat comprises a corresponding inner thread, whereby the pin is assembled on the hinge seat via screw connection. With the pin being screwed into the hinge seat, a removable connection is realized, allowing to exchange the pin if needed.

The hinge bracket preferably comprises a main part assembled to the cabinet and an arm on which the hinge seat is provided.

Preferably the hinge seat is provided at an extremity of the arm, preferably shaped as an open circle, which provides a flexible seat.

In a preferred embodiment, the pin is built in the shape of a deformed pipe with an axial gap, i.e. a gap running along its axial direction, providing an improvement in the flexibility of the pin.

Advantageously, the pin is built of metallic material. In this way, a pin with an axial gap can be easily manufactured by deforming a piece of sheet metal.

Preferably, the pin and the hinge bracket are designed to allow a complete/full rotation of the door of the household appliance which is arranged below the door hinge and therefore is pivotably arranged in the door hinge. In this way, no limitation to the rotation of the door is provided.

The advantages of the invention are especially as follows. By providing a door hinge with a deformed pin, a reliable and simple hinge construction is provided. Due to the fact that the pin is monolithically manufactured, preferably through the deformation of a sheet metal up to the resulting pin, and due to the assembly by interference, the resulting combination of pin and hinge bracket is cheap and easy to manufacture.

### BRIEF DESCRIPTION OF THE DRAWINGS

Further features and advantages of the present invention shall become clearer from the following detailed description of some of its preferred embodiments, made with reference to the attached schematic drawings and given as an indication and not for limiting purposes.

In particular, the attached drawings are included to provide a further understanding of the invention and are incorporated in and constitute a part of this specification. The drawings together with the description explain the principles of the invention. In the drawings, corresponding characteristics and/or components are identified by the same reference numbers. In these drawings:

FIG. 1 shows a refrigerating appliance arranged in a kitchen installation wall in a perspective view;

FIG. 2 shows the refrigerating appliance in the kitchen wall according to FIG. 1 in a lateral view;

FIG. 3 shows the refrigerating appliance according to FIG. 1 with closed doors in a perspective view;

FIG. 4 shows an enlarged view of FIG. 3;

FIG. 5 shows a top perspective view of appliance with the upper door opened;

FIG. 6 shows a hinge section of the refrigerating appliance;

FIG. 7 shows a hinge plate and a pin in an exploded view;

FIG. 8 shows the hinge plate and pin according to FIG. 12 in a mounted state;

FIG. 9 shows a cross-section through the configuration shown in FIG. 8 along line A-A of FIG. 10, and

FIG. 10 shows a top view of the hinge plate.

Identical parts are labeled with the same reference numbers.

### DETAILED DESCRIPTION OF THE INVENTION

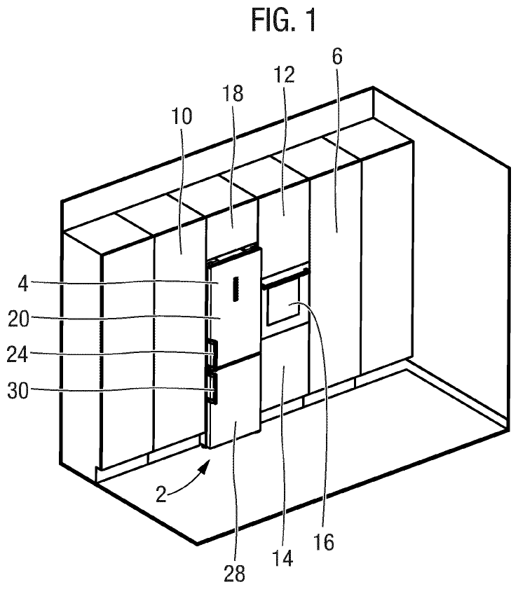

In FIG. 1, a refrigerating appliance 2 with casing 4 is shown within a kitchen installation wall 6 as part of a built-in kitchen. The refrigerating appliance 2 is preferably surrounded by further built-in components 10, 12, 14, 16. In the embodiment shown, components 10, 12, and 14 are preferably kitchen cabinets or lockers, whereas component 16 is a microwave oven.

The refrigerating appliance 2 comprises a cooling compartment with a first door 20 preferably with a handle 24 and preferably a freezing compartment with a second door 28 with a handle 30.

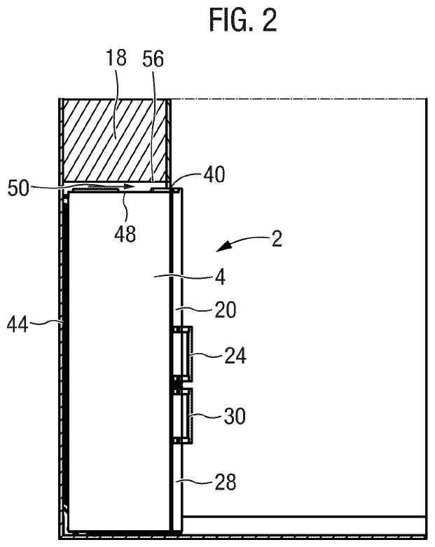

FIG. 2 shows a lateral view of the refrigerating appliance 2 with a casing 4 and doors 20, 28. At a frontal top side, refrigerating appliance 2 preferably comprises a cross bar 40. During operation of the refrigerating appliance 2, hot air is moving vertically upwards along at least part of back wall 44 of casing 4 and then between an upper wall 48 of casing 4 and a bottom wall 56 of component 18, as indicated by an arrow 50, and flows between cross bar 40 and bottom wall 56.

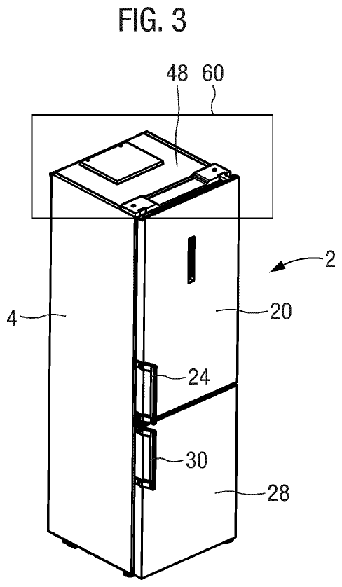

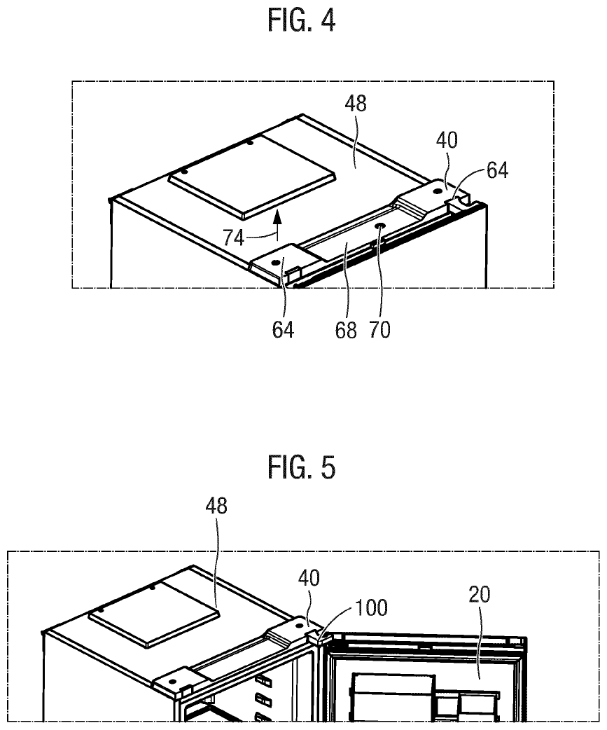

In FIG. 3, the refrigerating appliance 2 is shown in a perspective and stand-alone view in which the cross bar 40 can be clearly seen. An excerpt 60 of FIG. 3 is shown in greater detail FIG. 4. The cross bar 40 or crossbar comprises two lateral parts 64 or portions which are connected by a middle part 68. In the preferred embodiment shown, middle part 68 and lateral part 64 are integrally built, i.e. in a one-piece design. The middle part 68 preferably comprises a recessed region 70. In the present embodiment, the recessed region 70 is built in such a way that in a vertical direction 74 it has less height than the adjacent lateral parts 64.

In FIG. 5, a top region of alliance 2 is shown. The appliance 2 comprises a door hinge 100 which allows opening and closing of door 20.

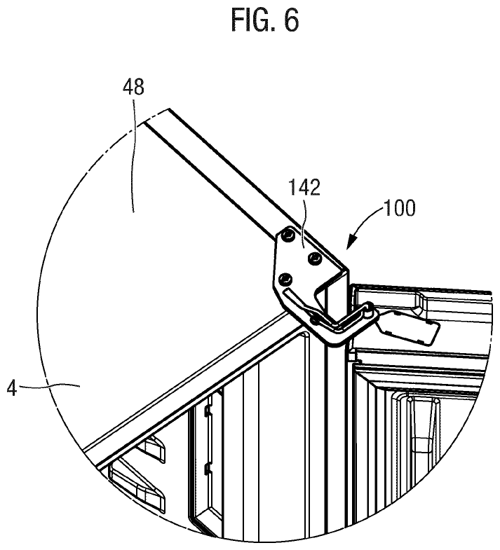

In FIG. 6, the top wall 48 of casing 4 of the appliance 2 is shown with the cross bar 40 removed. On top wall 48, a hinge bracket 142 is preferably arranged and is preferably secured to the casing 4 by several screws. The hinge bracket 142 is part of a door hinge 100.

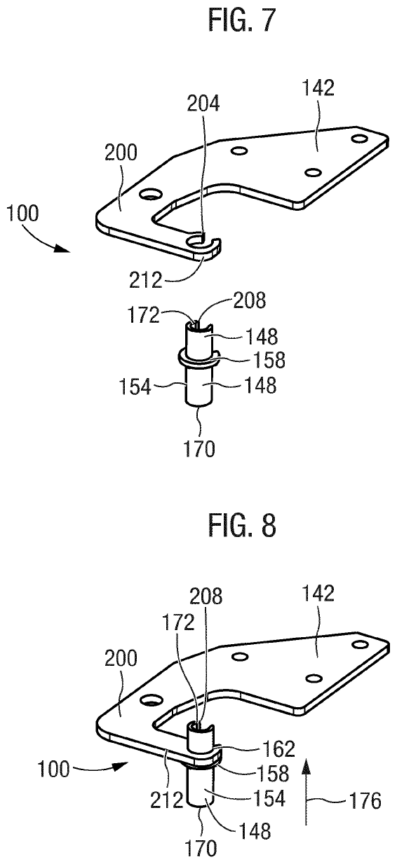

In FIG. 7, the hinge bracket 142 and a pin 148 of door hinge 100 are shown in an exploded view. The pin 148 comprises an essentially cylindrical main part 154 extending between a first end 170 and a second end 172. Between these two ends 170, 172, a deformed part 158 is built which has a larger radius than the cylindrical main part 154. The deformed part 158 is preferably built as a flange or a collar around the cylindrical main part 154. Preferably, deformed part 158 and cylindrical main part 154 are integrally built. The pin 148 is advantageously built by an injection molding process. Alternatively, the pin 148 is made of metallic material. The cylindrical main part 154 preferably is built as a hollow cylinder with a gap running in the axial direction. i.e. its circumference is not fully realized by material. In this way, the pin is provided with some flexibility in radial direction.

In the mounted state, the pin 148 is inserted into a seat 162 in hinge bracket 142. In FIG. 8, pin 148 is shown as it is inserted into seat 162. The deformed part 158 hinders the movement of the pin 148 in a direction 176 which in the mounted state of the appliance 2 corresponds to a vertical direction.

In a preferred embodiment, the pin 148 is assembled in seat 162 through mechanical interference, which advantageously implies that the diameter of the cylindrical main part 158 is greater than the diameter of the seat 162. Preferably or alternatively, the pin 148 is assembled on the seat 162 (hinge seat) through welding, i.e. the pin 148 is welded on seat 162. Advantageously, the pin 148 comprises an outer thread and the seat 162 comprises a corresponding inner thread, whereby the pin 148 is assembled on seat 162 via screw connection, i.e. pin 148 is screwed into seat 162.

In a preferred embodiment, the hinge bracket 142 comprises a main part assembled to the cabinet and an arm 200 (see for example FIG. 8) on which seat 162 is provided. The seat 162 advantageously is provided at an extremity 212 of the arm 200, preferably shaped as an open circle 204, which provides a flexible seat.

Preferably the pin 148 is built in the shape of a deformed pipe with an axial gap 208, i.e. a gap running along its axial direction, providing an improvement in the flexibility of the pin 148. In a preferred embodiment, the pin 148 and the hinge bracket 142 are designed to allow a complete/full rotation of the door of the refrigerating appliance 2 which is arranged below the hinge 136 and therefore is pivotably arranged in the hinge 136. In this way, no limitation to the rotation of the door 28 is provided.

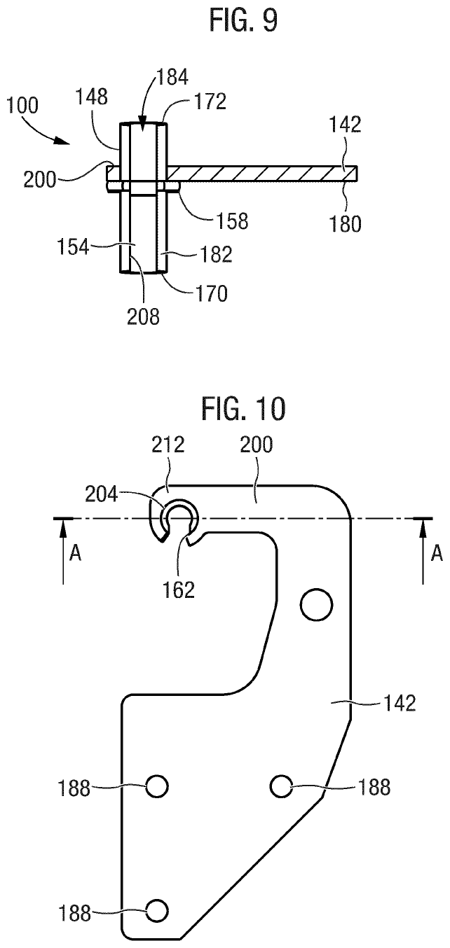

In the sectional view of FIG. 9, it can be seen how the deformed part 158 in the mounted state preferably lies against a surface 180 of the hinge bracket 142. The pin 148 is preferably built as a sheathing 182 with an axial gap 184.

In the top view shown in FIG. 10, it can be seen that the hinge bracket preferably has several openings 188 which allow screws to be lead through them for a screwing connection of the hinge bracket 142 to the casing 4.

The invention thus conceived can be subjected to numerous modifications and variants all falling within the scope of the inventive concept.

In addition, all details can be replaced by other technically equivalent elements. In practice, all the materials used, as well as the shapes and contingent dimensions, may vary depending on the requirements without departing from the scope of protection of the following claims.

### LIST OF REFERENCE NUMERALS

2 refrigerating appliance
4 casing
6 kitchen installation wall
10, 12 component
14, 16 component
20 door
24 handle
28 door
30 handle
40 cross bar
44 back wall
48 top wall
50 arrow
56 bottom wall
60 excerpt
64 lateral part
68 middle part
70 recessed region
74 vertical direction
100 door hinge
154 main part
158 deformed part
162 seat
170 first end
172 second end
176 direction
180 surface
182 sheathing
184 axial gap
188 opening
200 arm
204 open circle
208 axial gap
212 extremity

1. Household appliance (2), especially refrigerating appliance, comprising a casing (4) with a door hinge (100), whereby said door hinge (100) comprises a hinge bracket (142) and a pin (148) which is inserted into a corresponding hinge seat (162) provided on said hinge bracket (142),
characterized in that
said pin (148) comprises an essentially cylindrical part (154) with two ends (170, 172) and a deformed part (158) arranged in between said two ends (170, 172) with a diameter larger than the diameter of said cylindrical main part (154).

2. The household appliance (2) according to claim 1, whereby said main part (154) and said deformed part (158) are integrally built.

3. The household appliance (2) according to claim 1, whereby said pin (148) is built with a belt-like or flange-like shape.

4. The household appliance (2) according to claim 1, whereby said pin (148) is assembled on said hinge seat (162) through mechanical interference.

5. The household appliance (2) according to claim 1, whereby said pin (148) is assembled on said hinge seat (162) through welding.

6. The household appliance (2) according to claim 1, whereby said pin (148) comprises an outer thread and said hinge seat (162) comprises a corresponding inner thread, whereby said pin (148) is assembled on said hinge seat (162) via screw connection.

7. The household appliance (2) according to claim 1, whereby said hinge bracket (142) comprises a main part assembled to the cabinet and an arm on which the hinge seat (162) is provided.

8. The household appliance (2) according to claim 1, whereby said hinge seat (162) is provided at an extremity (212) of an arm (200), shaped as an open circle, which provides a flexible seat (162).

9. The household appliance (2) according to claim 1, whereby said pin (148) is built in the shape of a deformed pipe with an axial gap (208).

10. The household appliance (2) according to claim 1, whereby said pin (148) and said hinge bracket (142) are designed to allow a complete rotation of the door of the household appliance (2) which is arranged below the door hinge (100) and therefore is pivotably arranged in the door hinge (100).
